(19) United States
(12) Patent Application Publication
(10) Pub. No.: US 2026/0029907 A1
(43) Pub. Date: Jan. 29, 2026

(54) MOVEMENT CONTROL METHOD AND APPARATUS, STORAGE MEDIUM AND ELECTRONIC DEVICE

(71) Applicant: NETEASE (HANGZHOU) NETWORK CO., LTD., Hangzhou, Zhejiang (CN)

(72) Inventors: Lisha WANG, Hangzhou, Zhejiang (CN); Boyu HUANG, Hangzhou, Zhejiang (CN); Jiemeng CHI, Dalian, Liaoning (CN)

(73) Assignee: NETEASE (HANGZHOU) NETWORK CO., LTD., Hangzhou, Zhejiang (CN)

(21) Appl. No.: 18/998,137

(22) PCT Filed: Mar. 17, 2023
(86) PCT No.: PCT/CN2023/082259

§ 371 Date: Jan. 24, 2025

(30) Foreign Application Priority Data
Jul. 26, 2022 (CN) 202210886343.7

(51) Int. Cl. G06F 3/04847; A63F 13/2145; A63F 13/355; G06F 3/0488

(52) U.S. Cl. CPC G06F 3/04847; A63F 13/2145; A63F 13/355; G06F 3/0488

(57) ABSTRACT

A movement control method includes displaying a joystick domain through a preset first control region of a graphical user interface; controlling, in response to a first slide operation acting in the first control region, an operation point of the joystick domain to move along with movement of a touch control point of the first slide operation on the graphical user interface; in response to a second slide operation acting in a second control region located at a periphery of the first control region, controlling, based on a position change of a touch control point of the second slide operation, the operation point of the joystick domain to move in the first control region; and generating a movement control vector based on a relative position between the joystick domain and the operation point, and performing movement control based on the movement control vector.

### CROSS-REFERENCE TO RELATED APPLICATIONS

The present disclosure is a U.S. National Phase Application of International Application No. PCT/CN2023/082259, filed on Mar. 17, 2023, which claims the priority to the Chinese Patent Application No. 202210886343.7, entitled “MOVEMENT CONTROL METHOD AND APPARATUS, STORAGE MEDIUM AND ELECTRONIC DEVICE”, filed on Jul. 26, 2022, and the entire contents of both of which are incorporated herein by reference for all purposes.

### TECHNICAL FIELD

The present disclosure relates to the field of virtual interaction technology, and specifically to a movement control method and apparatus, a computer-readable storage medium, and an electronic device.

### BACKGROUND

In everyday life, it is often necessary to control movement of one or more objects, such as controlling airplanes and automobiles to move. In virtual scenes, it is also often necessary to control the movement of virtual objects. Controlling the movement of virtual objects through a joystick is a common control method.

It should be noted that the information disclosed in the above background section is only intended to enhance the understanding of the background of the present disclosure, and thus may include information that does not constitute prior art known to those ordinary skilled in the art.

### SUMMARY

The present disclosure provides a movement control method, a movement control apparatus, an electronic device, and a computer-readable storage medium.

According to an aspect of the present disclosure, there is provided a movement control method, where a graphical user interface is provided through a terminal device, the graphical user interface includes a preset first control region and a second control region located at a periphery of the first control region, and the method includes:
displaying a joystick domain through the first control region;
controlling, in response to a first slide operation acting in the first control region, an operation point of the joystick domain to move along with movement of a touch control point of the first slide operation on the graphical user interface;
in response to a second slide operation acting in the second control region, controlling, based on a position change of a touch control point of the second slide operation in the second control region, the operation point of the joystick domain to move in the first control region; and
generating a movement control vector based on a relative position between the joystick domain and the operation point, and performing movement control based on the movement control vector.

According to an aspect of the present disclosure, there is provided a non-transitory computer-readable storage medium storing a computer program, where the computer program, when executed by a processor, implements the method according to any one of the above.

According to an aspect of the present disclosure, there is provided an electronic device including a processor and a memory that is configured to store an executable instruction of the processor; where the processor is configured to perform, through executing the executable instruction, the method according to any one of the above.

It should be understood that the above general description and the later detailed description are only exemplary and explanatory, and do not limit the present disclosure.

### BRIEF DESCRIPTION OF THE DRAWINGS

The accompanying drawings herein are incorporated into the specification and form a part of the specification, illustrate embodiments in accordance with the present disclosure, and are used together with the specification to explain principles of the present disclosure. It is apparent that the accompanying drawings in the following description are only some of the embodiments of the present disclosure, and other accompanying drawings may be obtained based on these accompanying drawings without creative labor for those ordinary skilled in the art.

FIG. 1 shows a schematic diagram of a system architecture to which a movement control method and apparatus of embodiments of the present disclosure may be applied;

FIG. 2 schematically shows a flowchart of a movement control method according to an embodiment of the present disclosure;

FIG. 3 schematically shows a schematic interface diagram of a first control region according to an embodiment of the present disclosure;

FIG. 4 schematically shows a schematic interface diagram where a joystick domain is displayed in a fixed manner according to an embodiment of the present disclosure;

FIG. 5A schematically shows a schematic interface diagram where a joystick domain is displayed in response to a first touch control operation acting in a first sub-region according to an embodiment of the present disclosure;

FIG. 5B schematically shows a schematic interface diagram where a joystick domain is displayed in response to a second touch control operation acting in a second sub-region according to an embodiment of the present disclosure;

FIG. 6 schematically shows a schematic interface diagram where an operation point is controlled to follow in response to a first slide operation acting in a first control region according to an embodiment of the present disclosure;

FIG. 7 schematically shows a schematic interface diagram for sliding from a second control region to a first control region according to an embodiment of the present disclosure;

FIG. 8 schematically shows a schematic interface diagram for controlling in a second control region according to an embodiment of the present disclosure;

FIG. 9 schematically shows a block diagram of a structure of a movement control apparatus according to an embodiment of the present disclosure;

FIG. 10 schematically shows a schematic diagram of a structure of a computer system adapted to implement an electronic device of an embodiment of the present disclosure.

### DETAILED DESCRIPTION

Example embodiments are now described more comprehensively with reference to the accompanying drawings. However, the example embodiments can be implemented in a variety of forms, and should not be understood as limited to the examples described herein; on the contrary, providing these embodiments allows the present disclosure to be more comprehensive and complete, and comprehensively conveys the concept of the example embodiments to those skilled in the art. The described features, structures or characteristics may be combined in one or more embodiments in any suitable manner. In the following description, many specific details are provided to give a full understanding of the embodiments of the present disclosure. However, those skilled in the art will realize that the technical solution of the present disclosure may be practiced without one or more specific details, or by using other methods, components, devices, steps, etc. In other instances, well-known technical solutions are not shown or described in detail to avoid a reversal of the order of host and guest and obscuring various aspects of the present disclosure.

In addition, the accompanying drawings are only schematic illustrations of the present disclosure, and are not necessarily drawn to scale. The same reference numerals in the accompanying drawings indicate the same or similar parts, and thus repetitive descriptions of them will be omitted. Some block diagrams shown in the accompanying drawings are only functional entities, and do not necessarily correspond to physically or logically independent entities. These functional entities may be implemented in the form of software, or in one or more hardware modules or integrated circuits, or in different networks and/or processor devices and/or microcontroller devices.

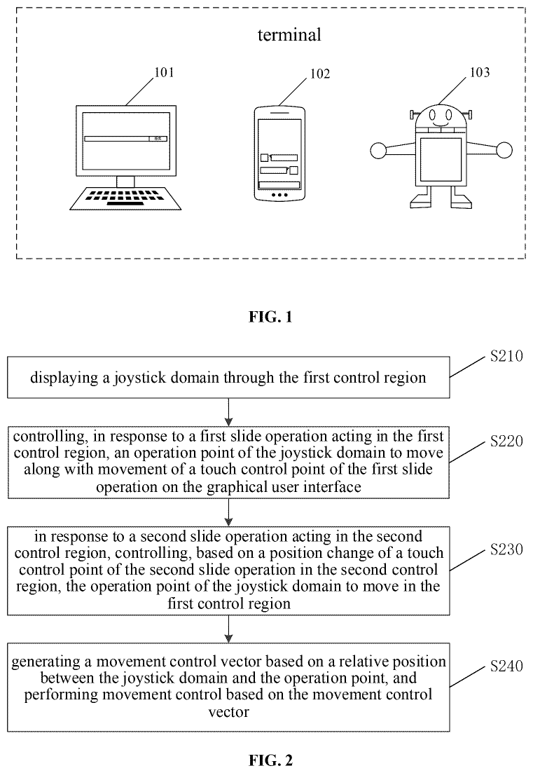

FIG. 1 shows a schematic diagram of an application environment to which a movement control method and apparatus of an embodiment of the present disclosure may be applied.

As shown in FIG. 1, the system architecture 100 may include one or more of the following: terminal devices 101, 102, 103. The terminal devices 101, 102, 103 may be various electronic devices having a display screen, including, but are not limited to, desktop computers, portable computers, smartphones, tablets, etc. The terminal device may install and run a virtual display program, a three-dimensional map program, a virtual game program, etc.

The movement control method in an embodiment of the present disclosure may be run on a local terminal device or a server. When the movement control method is run on a server, the method may be implemented and performed based on a cloud interaction system, where the cloud interaction system includes a server and a client device.

In an implementation, various cloud applications, e.g., cloud games, may be run under the cloud interaction system. Taking the cloud game as an example, the cloud game refers to a game mode based on cloud computing. In the operation mode of the cloud game, the operation body of the game program and the presentation body of the game image are separated, the storage and operation of the movement control method are completed on the cloud game server, and the client device is configured to receive and send data, and present the game image. For example, the client device may be a display device with data transmission functions near the user side, such as a terminal device, a TV, a computer, a PDA, etc.; and the cloud game server in the cloud performs the information processing. When playing a game, the player operates the client device to send operation instructions to the cloud game server, and the cloud game server runs the game according to the operation instructions, encodes and compresses data such as the game image, and returns the data to the client device through the network. Finally, the game image is decoded and output through the client device.

In an embodiment, taking the game as an example, a local terminal device stores a game program and is configured to present the game image. The local terminal device is configured to interact with the player through a graphical user interface, i.e., the game program is conventionally downloaded, installed, and run via the terminal device. The local terminal device may provide the graphical user interface to the player in a variety of ways, for example, the graphical user interface may be rendered and displayed on the display screen of the terminal or, provided to the player through holographic projection. For example, the local terminal device may include a display screen and a processor, the display screen is configured to display the graphical user interface, the graphical user interface includes the game image, and the processor is configured to run the game, generate the graphical user interface, and control the display of the graphical user interface on the display screen.

The flowcharts and block diagrams in the accompanying drawings illustrate the system architecture, function, and operation that may be implemented according to the system, method, and computer program product of various embodiments of the present disclosure. At this point, each box in the flowcharts or block diagrams may represent a module, a program segment, or a part of code, and the module, the program segment, or the part of code described above includes one or more executable instructions used for implementing specified logical functions. It should also be noted that in some implementations as replacements, the functions indicated in the boxes may also occur in a different order than that indicated in the accompanying drawings. For example, two consecutively represented boxes may actually be executed substantially in parallel, and they may sometimes be executed in a reverse order, depending on the functions involved. It should also be noted that each box in the block diagrams or flowcharts, and combinations of boxes in the block diagrams or flowcharts, may be implemented by using a specialized hardware-based system that performs the specified function or operation, or may be implemented by using a combination of specialized hardware and computer instructions.

The units described and involved in the embodiments of the present disclosure may be implemented by means of software, or may be implemented by means of hardware. The described units may also be provided in a processor. In some embodiments, the name of the unit does not constitute a limitation of the unit itself in certain circumstances.

Taking virtual games as an example, users control virtual characters through the joystick provided by an interface. Currently, there are three solutions. One is a fixed joystick, where the user can only operate in a limited joystick region. The second is a semi-fixed joystick, where the joystick is generated at a corresponding position based on an initial operation, and the user also can only operate in a limited joystick region until the next re-operation generates a new joystick region. The third is a following joystick, where the joystick region constantly changes with the operation of the user. In the above solutions, either the operation range of the user is highly restricted or the operation consistency is poor.

It should be noted that the present disclosure may control a virtual object or a virtual character to move in a virtual scene, for example, it may be that the virtual object in the game includes a virtual character, or a virtual object in a three-dimensional map program, etc. The virtual scene involved in the embodiments of the present disclosure may be a digitized scene outlined through digitization technology by an intelligent terminal device such as a computer, a cell phone, a tablet computer, and the like. The virtual scene may include constructions or structures such as houses, buildings, gardens, bridges, pools, etc., and may also include natural landscapes such as mountains, rivers, lakes, etc., as well as arbitrary virtual objects or virtual props such as weapons, tools, creatures, etc. The virtual scene may be a simulation scene of the real world, a purely fictional virtual scene, or a partially simulated and partially fictional virtual scene, and this embodiment does not make any special limitations thereon.

Referring to FIG. 2, in the movement control method, a graphical user interface is provided through a terminal device, the graphical user interface includes a preset first control region and a second control region located at a periphery of the first control region, and the method includes steps S210 to S240.

At step S210, a joystick domain is displayed through the first control region.

At step S220, an operation point of the joystick domain is controlled, in response to a first slide operation acting in the first control region, to move along with movement of a touch control point of the first slide operation on the graphical user interface.

At step S230, in response to a second slide operation acting in the second control region, the operation point of the joystick domain is controlled, based on a position change of a touch control point of the second slide operation in the second control region, to move in the first control region.

At step S240, a movement control vector is generated based on a relative position between the joystick domain and the operation point, and movement control is performed based on the movement control vector.

In the movement control method provided in the embodiments of the present disclosure, the joystick domain is displayed through the first control region; the operation point of the joystick domain is controlled, in response to the first slide operation acting in the first control region, to move along with the movement of the touch control point of the first slide operation on the graphical user interface; in response to the second slide operation acting in the second control region, the operation point of the joystick domain is controlled, based on the position change of the touch control point of the second slide operation in the second control region, to move in the first control region; and the movement control vector is generated based on the relative position between the joystick domain and the operation point for the movement control. The implementation of the embodiments of the present disclosure, on the one hand, avoids that the user only can operate in the fixed or semi-fixed joystick domain, improves the operable range, and thus improves the ease of operation; on the other hand, the implementation of the embodiments of the present disclosure makes the joystick domain not keep following the operation of the user at all times, avoids the need for interrupting the operation when the joystick domain is moved to an inconvenient place or when it is necessary to change the direction of the movement, and improves the consistency of the movement control interaction. In the following, the above steps are described in more detail.

In the present disclosure, the first control region is determined on the graphical user interface provided by the terminal device. The first control region is at a position where the user can most conveniently perform a movement control operation. The first control region may be at a lower left side of the graphical user interface, or at other positions under different movement control scenes. The first control region may be a circle. The first sub-region is a small circle in the circle of the first control region. The second sub-region is a ring surrounding the first sub-region. The combination of the first sub-region and the second sub-region is the first control region. The radius of the first sub-region may be half of the radius of the first control region. The width of the ring of the second sub-region may be equal to the length of the radius of the circle of the first sub-region. Under different movement control scenes, the shape of the first control region, the shape of the first sub-region, and the shape of the second sub-region may be freely configured, the above relationship between the radius and the width may be changed, and the embodiments of the present disclosure do not make limitations herein.

It can be understood that the region range of the first control region, and the region range of the second control region may be visible or invisible.

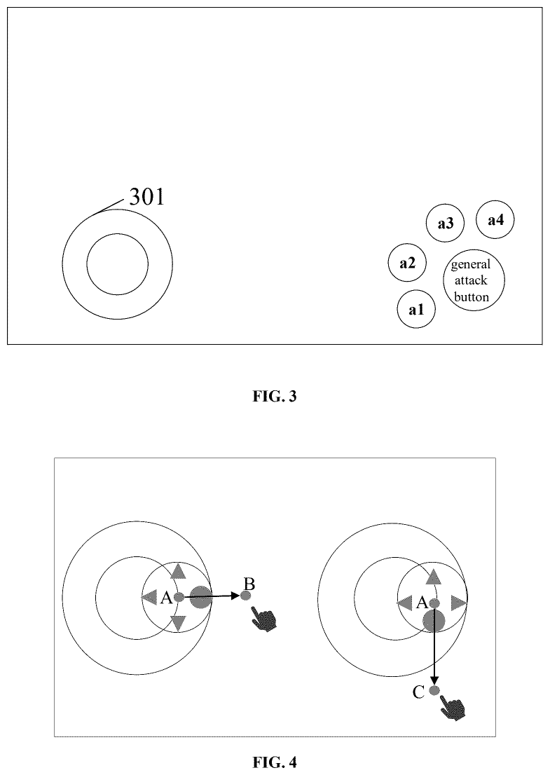

By way of example, as shown in FIG. 3, the first control region 301 is located in the lower left corner of the horizontally disposed graphical user interface, and the region outside the first control region 301 is the second control region. The specific region of the second control region is not limited. The second control region may be a ring region surrounding the first control region 301. Controls that control the virtual character to release a skill or perform an action may be provided at the right side. The first control region 301 includes the first sub-region corresponding to the small circle, and the second sub-region corresponding to the ring surrounding the small circle.

At step S210, the joystick domain is displayed through the first control region.

In the embodiments of the present disclosure, the joystick domain is displayed in the first control region, and the joystick domain may include a base plate and an operation point. When operations are not started, the position of the operation point may be defaulted to the center of the joystick domain, or the operation point may not be displayed. When the operation point is configured to always be located in the joystick domain, the region of the joystick domain on the graphical user interface may be the same as the region of its base plate.

At step S220, the operation point of the joystick domain is controlled, in response to the first slide operation acting in the first control region, to move along with the movement of the touch control point of the first slide operation on the graphical user interface.

In the embodiments of the present disclosure, in response to the first slide operation acting in the first control region, the position of the touch control point of the first slide operation on the graphical user interface is obtained, and the operation point of the joystick domain is controlled to move along with the movement of the touch control point. The touch control position of the first slide operation may be determined by monitoring the slide event and the point contacting event, or by monitoring the screen pressure change, and then the position coordinates of the touch control point is obtained.

At step S230, in response to the second slide operation acting in the second control region, the operation point of the joystick domain is controlled, based on the position change of the touch control point of the second slide operation in the second control region, to move in the first control region.

In the embodiments of the present disclosure, the second slide operation may be an operation continuous with the first slide operation, i.e., the user slides out of the first control region and slides into the second control region. At this time, the first touch control point of the second slide operation in the second control region is a point immediately adjacent to the first control region. The second slide operation may also be an operation independent of the first slide operation, i.e., the first touch control point may be any point in the second control region.

In response to the second slide operation acting in the second control region, where the second slide operation may be an operation continuous with the first slide operation, i.e., the user slides out of the first control region and slides into the second control region, firstly, the base plate of the joystick domain may be displayed, based on the position of the touch control point of the second slide operation initially acting in the second control region, in a fixed manner in the first control region.

In displaying the joystick domain in a fixed manner, the center of the joystick domain may be determined on a connection line between the first control region and the first touch control point of the second slide operation in the second control region, and the base plate of the joystick domain is inscribed with the first control region, the position where the base plate of the joystick domain is inscribed with the first control region is determined as a position where the connection line between the first control region and the first touch control point intersects with the first control region.

By way of example, as described in FIG. 4, the base plate of the joystick domain is a circle, the center of the joystick domain is located at point A, point B may be a point located directly to the right of the joystick domain and outside the joystick domain, and point C may be a point located directly below the joystick domain and outside the joystick domain. During the movement of the touch control point of the second slide operation from point B to point C, the joystick domain is displayed in a fixed manner, no position change occurs to the joystick domain, and only the movement control vector is changed.

In determining the operation point of the joystick domain, a connection line is determined based on the position of the touch control point and the center of the joystick domain, and an intersection point between the connection line and the edge of the joystick domain is taken as the position where the operation point of the joystick domain is inscribed with the base plate of the joystick domain. With continued reference to FIG. 4, the operation point is visualized as a small circle on the base plate of the joystick domain. However, it can be understood that the intersection point between the connection line and the edge of the joystick domain may also be used directly as the center of the circle corresponding to the operation point, and at this time, the circle is on the edge of the first control region, rather than being inscribed with the edge. The embodiments of the present disclosure do not make special limitations herein.

At step S240, the movement control vector is generated based on the relative position between the joystick domain and the operation point, and the movement control is performed based on the movement control vector.

In the embodiments of the present disclosure, the movement control vector is generated based on the relative position between the joystick domain and the operation point. For example, if the position of the operation point is determined based on the touch control point, and the operation point may be at a rightward portion of the joystick domain, then the movement control vector generated based thereon may control the virtual character to walk to the right; and the operation point may be at an upper left portion of the joystick domain, then the movement control vector generated based thereon may control the virtual character to walk to the front left side.

It can be understood that based on the joystick domain of the same position, two operation points at different positions in the same direction may have other different controls other than controlling the virtual character to walk in the same direction. For example, the joystick domain is a circle with a radius of three units, the first operation point is located directly to the right of the center of the circle with a distance between the first operation point and the center of the circle being one unit, and the second operation point is located directly to the right of the center of the circle with a distance between the second operation point and the circle being two units. Then, the first operation point may correspond to a movement speed of 10, and the second operation point may correspond to a movement speed of 20; that is to say, the first operation point may correspond to walking to the right, and the second operation point may correspond to running to the right. The embodiments of the present disclosure do not make limitations herein.

The present disclosure also provides an implementation manner of the movement control method. The first control region includes a first sub-region and a second sub-region located at a periphery of the first sub-region. The step of displaying the joystick domain through the first control region includes:
in response to a first touch control operation acting in the first sub-region of the first control region, determining a touch control position of the first touch control operation as a center of the joystick domain, and displaying the joystick domain; or
in response to a second touch control operation acting in the second sub-region of the first control region, determining the center of the joystick domain based on a touch control position of the second touch control operation and a center of the first sub-region, and displaying the joystick domain.

In the embodiments of the present disclosure, the first control region includes the first sub-region and the second sub-region located at the periphery of the first sub-region. The first sub-region may be a circle. The second sub-region may be a ring surrounding the first sub-region.

When the joystick domain is displayed in response to the touch control operation acting in the first control region, the touch control point may be in the first sub-region or in the second sub-region. In response to the first touch control operation acting in the first sub-region, the joystick domain is displayed, by using the touch control position of the first touch control operation as the center of the joystick domain, based on the preset value of the radius of the joystick domain.

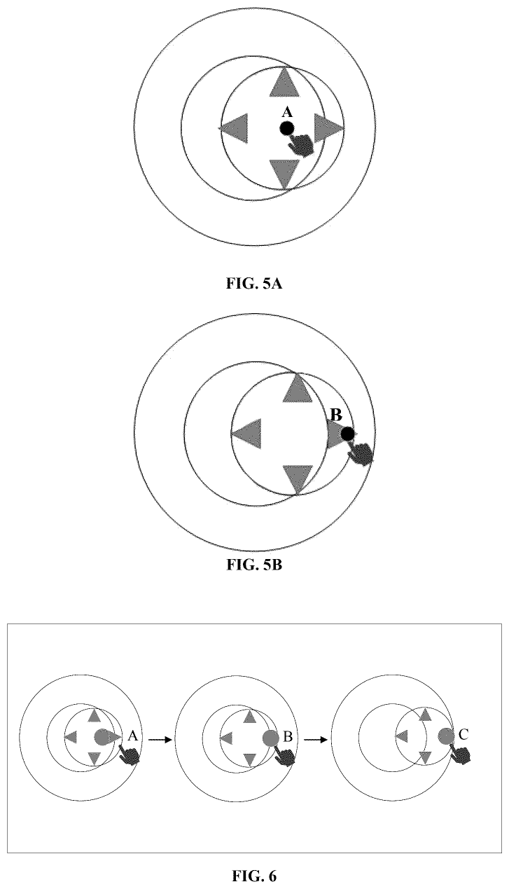

By way of example, as shown in FIG. 5A, the circle in the middle is the first sub-region, and the second sub-region is a ring. Point A is any point in the first sub-region. Based on the touch control position at point A, the center of the joystick domain is determined and the joystick domain is displayed. Since the joystick domain is displayed based on the touch control position, the touch control position is at the center of the joystick domain. At this time, no movement control vector is generated, and the controlled virtual character may remain stationary or maintain the original movement state without adjustment.

In response to the second touch control operation acting in the second sub-region, based on the touch control position of the second touch control operation and the center of the first sub-region, the center of the joystick domain is determined and the joystick domain is displayed. In this embodiment, a connection line is determined based on the touch control position and the center of the first sub-region, and the center of the joystick domain is located on the connection line. The touch control position is taken as the position of the center of the circle corresponding to the operation point, and the circle corresponding to the operation point is inscribed with the joystick domain. Based on the preset value of the radius of the base plate of the joystick domain, the position where the center of the joystick domain is located may be determined, and the joystick domain may be displayed.

For example, as shown in FIG. 5B, the circle in the middle is the first sub-region, and the second sub-region is a ring. Point B is any point in the second sub-region. Based on the touch control position at point B, the center of the joystick domain is determined, and the joystick domain is displayed. The process of determining the center of the joystick domain and displaying the joystick domain is as above, and is not further described herein.

The present disclosure also provides an implementation manner of the movement control method. The step of controlling, in response to the first slide operation acting in the first control region, the operation point of the joystick domain to move along with the movement of the touch control point of the first slide operation on the graphical user interface includes:
in response to the first slide operation acting in the first control region, when the touch control point of the first slide operation is located within the joystick domain, controlling the base plate of the joystick domain to remain stationary, and controlling the operation point of the joystick domain to move along with the movement of the touch control point; and
when the touch control point of the first slide operation is located in an area within the first control region other than the joystick domain, controlling the base plate and the operation point of the joystick domain to move along with the movement of the touch control point.

In the embodiments of the present disclosure, when the touch control point of the first slide operation is located in the current joystick domain, the position of the base plate of the joystick domain is controlled to remain stationary, and only the position of the operation point moves along with the position of the touch control point. For example, as shown in FIG. 6, both touch control points A and B are located within the range of the joystick domain, and the display position of the joystick domain remains unchanged during the movement of the first slide operation from touch control point A to touch control point B. If the joystick domain corresponding to touch control points A and B is taken as the initial joystick domain, point C is in an area outside the initial joystick domain. Therefore, when the touch control point of the first slide operation is at point C, the base plate and the operation point of the joystick domain are controlled to move along with the movement of the touch control point. During this process, the circle corresponding to the operation point maintains inscribed with the joystick domain.

The implementation of the embodiments of the present disclosure, through controlling the base plate of the joystick domain to remain stationary when the touch control point of the first slide operation is located within the joystick domain, and controlling the base plate and the operation point of the joystick domain to move along with the movement of the touch control point when the touch control point is located in an area within the first control region other than the joystick domain, can avoid the operation range being too large, still allows the range in which the user can perform the movement control operation to be expanded, improving the convenience and fault tolerance of the operation.

Since the first control region is actually a relatively suitable region for the user to perform the movement control operation, during the process of the movement operation of the user, even if the user performs the movement control in the second control region, the user will largely return to the first control region again for performing the movement control during the process of the movement operation.

Based on this, the present disclosure also provides an implementation manner of the movement control method. The method further includes:
controlling, in response to a third slide operation sliding from the second control region to the first control region, the joystick domain to translate from a current position towards a direction of a current movement control vector until the joystick domain is inscribed with the first control region, where the operation point of the joystick domain is displayed at a touch control position of the third slide operation in the first control region.

In the embodiments of the present disclosure, firstly, the joystick domain is currently displayed in a fixed manner in the first control region. In response to the third slide operation sliding from the second control region to the first control region, based on the position where the third slide operation first touches the first control region, a movement control vector at this time is determined, the joystick domain is controlled to translate from the current position towards the direction of the current movement control vector until the joystick domain is inscribed with the first control region, and at this time, the position where the circle corresponding to the operation point located in the joystick domain is inscribed with the first touch control region is the same as the touch control position of the third slide operation.

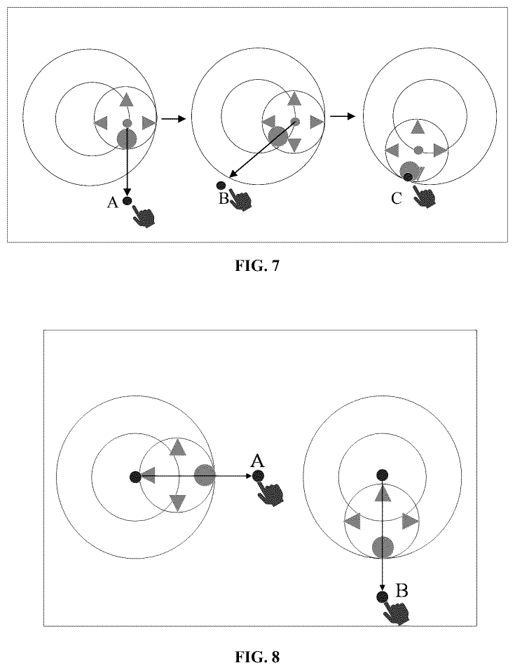

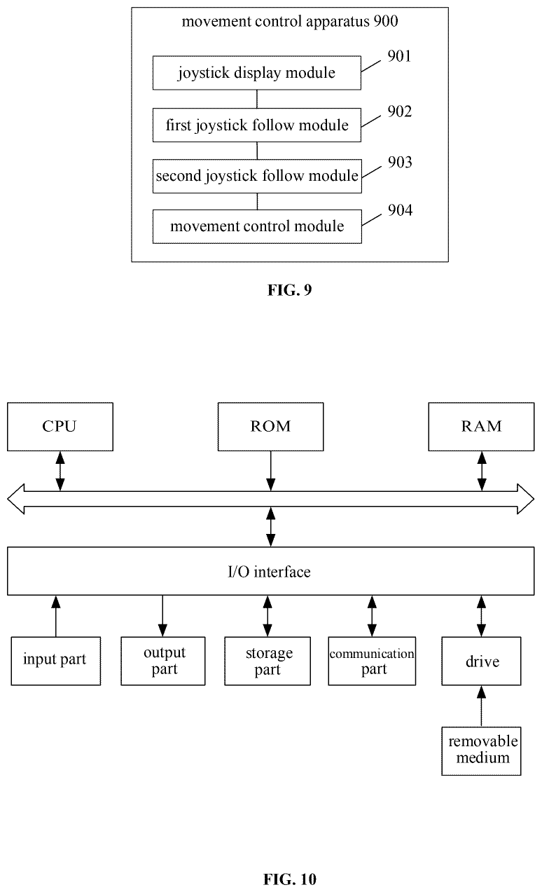

For example, as shown in FIG. 7, point A is a touch control point located directly below the joystick domain and outside the first control region; point B is a touch control point located at the lower left side of the joystick domain and outside the first control region; and point C is a touch control point located at the lower left side of the joystick domain and in the first control region. The third slide operation slides from point A to point B, and the position of the circle corresponding to the operation point in the corresponding joystick domain follows the change; and in response to the third slide operation sliding from point B to point C, the position of the joystick domain is moved to be inscribed with the first control region.

The implementation of the embodiments of the present disclosure, through controlling, in response to the third slide operation sliding from the second control region to the first control region, the joystick domain to translate from the current position towards the direction of the current movement control vector until the joystick domain is inscribed with the first control region, can avoid the joystick domain from moving along with the slide operation in a large range, thereby avoiding the range of the interaction control from being too large, and improving the convenience in the interaction process of the movement control.

The present disclosure also provides an implementation manner of the movement control method. The step of in response to the second slide operation acting in the second control region, controlling, based on the position change of the touch control point of the second slide operation in the second control region, the operation point of the joystick domain to move in the first control region includes:
in response to the second slide operation acting in the second control region, determining a connection line based on the touch control point of the second slide operation and a center of the first control region, and determining an intersection point between the connection line and an edge of the first control region as a point where the operation point and the base plate of the joystick domain are inscribed with the first control region respectively; and
based on the position change of the touch control point in the second control region, controlling the operation point and the base plate of the joystick domain to move in the first control region respectively while maintaining inscribed with the first control region.

In the embodiments of the present disclosure, the second slide operation acts in the second control region, a connection line is determined based on the touch control point of the second slide operation and the center of the first control region, and the intersection point between the connection line and the edge of the first control region is determined as the point where the operation point and the base plate of the joystick domain are inscribed with the first control region respectively.

When the second slide operation is continuously performed in the second control region, during the movement of the joystick domain in the first control region, the operation point and the base plate of the joystick domain maintain inscribed with the first control region respectively. In some embodiments, the base plate and the operation point are controlled to move in the first control region by the same angle according to the angle formed by the different connection lines between the different touch control points of the second slide operation and the center of the first control region.

For example, as shown in FIG. 8, point A is a touch control point located directly to the right of the joystick domain and outside the first control region; and point B is a touch control point located directly below the joystick domain and outside the first control region. When the touch control point of the second slide operation moves from point A to point B, the angle formed by the connection line between A and the first control region and the connection line between B and the first control region is 90 degrees. Correspondingly, the base plate and the operation point of the joystick domain are controlled to move by 90 degrees in the first control region while maintaining inscribed line with the edge of the first control region.

The implementation of the embodiments of the present disclosure, through displaying the joystick domain in the first control region and moving the joystick domain correspondingly in response to the position change of the control operation in the second control region, can expand the operable region of the user, improving the operation efficiency and fault tolerance.

It should be noted that although the steps of the method in the present disclosure are described in a specific order in the accompanying drawings, it is not required or implied that these steps must be performed in that specific order, or that all of the steps shown must be performed to achieve the desired results. Additionally or alternatively, some steps may be omitted, a plurality of steps may be merged into one step for execution, and/or one step may be decomposed into a plurality of steps for execution.

Further, in the present disclosure, there is also provided a movement control apparatus, where a graphical user interface is provided through a terminal device, the graphical user interface includes a preset first control region and a second control region located at a periphery of the first control region, and the apparatus 900 includes:
a joystick display module 901, configured to perform displaying a joystick domain through the first control region;
a first joystick follow module 902, configured to perform controlling, in response to a first slide operation acting in the first control region, an operation point of the joystick domain to move along with movement of a touch control point of the first slide operation on the graphical user interface;
a second joystick follow module 903, configured to perform controlling based on a position change of a touch control point of the second slide operation in the second control region, in response to a second slide operation acting in the second control region, the operation point of the joystick domain to move in the first control region; and
a movement control module 904, configured to perform generating a movement control vector based on a relative position between the joystick domain and the operation point, and conducting movement control based on the movement control vector.

In an embodiment of the present disclosure, the first control region includes a first sub-region and a second sub-region located at a periphery of the first sub-region; and the joystick display module is configured to perform: in response to a first touch control operation acting in the first sub-region of the first control region, determining a touch control position of the first touch control operation as a center of the joystick domain, and displaying the joystick domain; or
in response to a second touch control operation acting in the second sub-region of the first control region, determining the center of the joystick domain based on a touch control position of the second touch control operation and a center of the first sub-region, and displaying the joystick domain.

In an embodiment of the present disclosure, a radius of a base plate of the joystick domain is a preset value, and the joystick display module is configured to perform: determining a connection line based on the touch control position of the touch control operation and the center of the first sub-region; and
generating in the first control region, based on the connection line, the joystick domain with a radius of the preset value, wherein the center of the joystick domain is located on the connection line, a circle corresponding to the operation point of the joystick domain is inscribed with the base plate, and the operation point is located at the touch control position.

In an embodiment of the present disclosure, the first joystick follow module is configured to perform: in response to the first slide operation acting in the first control region, when the touch control point of the first slide operation is located within the joystick domain, controlling a base plate of the joystick domain to remain stationary, and controlling the operation point of the joystick domain to move along with the movement of the touch control point; and
when the touch control point of the first slide operation is located in an area within the first control region other than the joystick domain, controlling the base plate and the operation point of the joystick domain to move along with the movement of the touch control point.

In an embodiment of the present disclosure, the second joystick follow module is configured to perform displaying in the first control region, based on a starting point of the second slide operation in the second control region, a base plate of the joystick domain in a fixed manner;
determining a connection line between the touch control point of the second slide operation and a center of the joystick domain, and determining an intersection point between the connection line and an edge of the joystick domain as a position where the operation point of the joystick domain is inscribed with the base plate of the joystick domain; and
controlling, based on the position change of the touch control point of the second slide operation in the second control region, the operation point of the joystick domain to maintain inscribed with the base plate and move on the base plate of the joystick domain.

In an embodiment of the present disclosure, the apparatus further includes:
a return control module, configured to perform controlling, in response to a third slide operation sliding from the second control region to the first control region, the joystick domain to translate from a current position towards a direction of a current movement control vector until the joystick domain is inscribed with the first control region, where the operation point of the joystick domain is displayed at a touch control position of the third slide operation in the first control region.

In an embodiment of the present disclosure, the second joystick follow module is configured to perform: in response to the second slide operation acting in the second control region, determining a connection line based on the touch control point of the second slide operation and a center of the first control region, and determining an intersection point between the connection line and an edge of the first control region as a point where the operation point and a base plate of the joystick domain are inscribed with the first control region respectively; and
based on the position change of the touch control point in the second control region, controlling the operation point and the base plate of the joystick domain to move in the first control region respectively while maintaining inscribed with the first control region.

In an embodiment of the present disclosure, an angle at which the base plate moves in the first control region, and an angle at which the operation point moves in the first control region are the same as an angle at which the touch control point of the second slide operation moves in the second control region, respectively.

FIG. 10 schematically shows a schematic diagram of a structure of a computer system adapted to implement a terminal device of an embodiment of the present disclosure.

It should be noted that the computer system of the terminal device shown in FIG. 10 is only an example, and should not bring any limitation to the functions and scope of use of the embodiments of the present disclosure.

As shown in FIG. 10, the computer system includes a central processing unit (CPU). The CPU can perform various appropriate actions and processes based on a program stored in a read-only memory (ROM) or loaded from a storage part into a random access memory (RAM). Various programs and data required for the operation of the system are also stored in the RAM. The CPU, ROM and RAM are connected to each other via a bus. The input/output (I/O)) interface is also connected to the bus.

The following components are connected to the I/O interface; an input part including a key board, a mouse, etc.; an output part including a cathode ray tube (CRT), a liquid crystal display (LCD), etc., and a speaker, etc.; a storage part including a hard disk, etc.; and a communication part including a network interface card such as a LAN card, a modem, etc. The communication part performs communication processing via a network such as the Internet. The drive is also connected to the I/O interface as needed. The removable medium, such as a disk, a CD-ROM, a magneto-optical disk, a semiconductor memory, etc., is mounted to the drive as needed, facilitating that computer programs read therefrom are mounted into the storage part as needed.

In particular, according to the embodiments of the present disclosure, the process described below with reference to the flowchart may be implemented as a computer software program. For example, the embodiments of the present disclosure include a computer program product, and the computer program product includes a computer program carried on a computer-readable medium. The computer program includes program code for performing the method shown in the flowchart. In such embodiments, the computer program may be downloaded and installed from the network via the communication part, and/or installed from the removable medium. When the computer program is executed by the CPU, the following method steps may be realized.

A movement control method, where a graphical user interface is provided through a terminal device, the graphical user interface includes a preset first control region and a second control region located at a periphery of the first control region, and the method includes:
displaying a joystick domain through the first control region;
controlling, in response to a first slide operation acting in the first control region, an operation point of the joystick domain to move along with movement of a touch control point of the first slide operation on the graphical user interface;
in response to a second slide operation acting in the second control region, controlling, based on a position change of a touch control point of the second slide operation in the second control region, the operation point of the joystick domain to move in the first control region; and
generating a movement control vector based on a relative position between the joystick domain and the operation point, and performing movement control based on the movement control vector.

In an embodiment of the present disclosure, the first control region includes a first sub-region and a second sub-region located at a periphery of the first sub-region; and the step of displaying the joystick domain through the first control region includes:
in response to a first touch control operation acting in the first sub-region of the first control region, determining a touch control position of the first touch control operation as a center of the joystick domain, and displaying the joystick domain; or
in response to a second touch control operation acting in the second sub-region of the first control region, determining the center of the joystick domain based on a touch control position of the second touch control operation and a center of the first sub-region, and displaying the joystick domain.

In an embodiment of the present disclosure, a radius of a base plate of the joystick domain is a preset value; and the step of determining the center of the joystick domain based on the touch control position of the second touch control operation and the center of the first sub-region and displaying the joystick domain includes:
determining a connection line based on the touch control position of the touch control operation and the center of the first sub-region; and
generating in the first control region, based on the connection line, the joystick domain with a radius of the preset value, where the center of the joystick domain is located on the connection line, a circle corresponding to the operation point of the joystick domain is inscribed with the base plate, and the operation point is located at the touch control position.

In an embodiment of the present disclosure, the step of controlling, in response to the first slide operation acting in the first control region, the operation point of the joystick domain to move along with the movement of the touch control point of the first slide operation on the graphical user interface includes:
in response to the first slide operation acting in the first control region, when the touch control point of the first slide operation is located within the joystick domain, controlling a base plate of the joystick domain to remain stationary, and controlling the operation point of the joystick domain to move along with the movement of the touch control point; and
when the touch control point of the first slide operation is located in an area within the first control region other than the joystick domain, controlling the base plate and the operation point of the joystick domain to move along with the movement of the touch control point.

In an embodiment of the present disclosure, the step of controlling, based on the position change of the touch control point of the second slide operation in the second control region, the operation point of the joystick domain to move in the first control region includes:
displaying in the first control region, based on a starting point of the second slide operation in the second control region, a base plate of the joystick domain in a fixed manner;
determining a connection line between the touch control point of the second slide operation and a center of the joystick domain, and determining an intersection point between the connection line and an edge of the joystick domain as a position where the operation point of the joystick domain is inscribed with the base plate of the joystick domain; and
controlling, based on the position change of the touch control point of the second slide operation in the second control region, the operation point of the joystick domain to maintain inscribed with the base plate and move on the base plate of the joystick domain.

In an embodiment of the present disclosure, the method further includes:
controlling, in response to a third slide operation sliding from the second control region to the first control region, the joystick domain to translate from a current position towards a direction of a current movement control vector until the joystick domain is inscribed with the first control region, where the operation point of the joystick domain is displayed at a touch control position of the third slide operation in the first control region.

In an embodiment of the present disclosure, the step of in response to the second slide operation acting in the second control region, controlling, based on the position change of the touch control point of the second slide operation in the second control region, the operation point of the joystick domain to move in the first control region includes:
in response to the second slide operation acting in the second control region, determining a connection line based on the touch control point of the second slide operation and a center of the first control region, and determining an intersection point between the connection line and an edge of the first control region as a point where the operation point and a base plate of the joystick domain are inscribed with the first control region respectively; and
based on the position change of the touch control point in the second control region, controlling the operation point and the base plate of the joystick domain to move in the first control region respectively while maintaining inscribed with the first control region.

In an embodiment of the present disclosure, an angle at which the base plate moves in the first control region, and an angle at which the operation point moves in the first control region are the same as an angle at which the touch control point of the second slide operation moves in the second control region, respectively.

Specific contents of the embodiments of the movement control method operated in this embodiment are equally applicable to the contents of the embodiment of the movement control method described in the foregoing, and therefore are not repeated herein.

In the movement control method provided in the embodiments of the present disclosure, the joystick domain is displayed through the first control region; the operation point of the joystick domain is controlled, in response to the first slide operation acting in the first control region, to move along with the movement of the touch control point of the first slide operation on the graphical user interface; in response to the second slide operation acting in the second control region, the operation point of the joystick domain is controlled, based on the position change of the touch control point of the second slide operation in the second control region, to move in the first control region; and the movement control vector is generated based on the relative position between the joystick domain and the operation point, and the movement control is performed based on the movement control vector. The implementation of the embodiments of the present disclosure, on the one hand, avoids that the user only can operate in the fixed or semi-fixed joystick domain, improves the operable range, and thus improves the ease of operation; on the other hand, the implementation of the embodiments of the present disclosure makes the joystick domain not keep following the operation of the user at all times, avoids the need for interrupting the operation when the joystick domain is moved to an inconvenient place or when it is necessary to change the direction of the movement, and improves the consistency of the movement control interaction.

It should be noted that although one or more modules or units of the device for action execution are described in the detailed description above, this division is not mandatory. Indeed, according to the embodiments of the present disclosure, the features and functions of two or more modules or units described above may be specified in a single module or unit. Conversely, the features and functions of one module or unit described above may be further divided to be materialized by a plurality of modules or units.

Since the functional modules of the device for placement of virtual props in the virtual scene of the example embodiments of the present disclosure correspond to the steps of the above-described example embodiments of the method for placement of virtual props in the virtual scene, for the details and effects that are not disclosed in the example embodiments of the device of the present disclosure, please refer to the example embodiments of the above-described method for placement of virtual props in the virtual scene of the present disclosure.

These modules above may be one or more integrated circuits configured to implement the above method, such as one or more application specific integrated circuits (ASICs), one or more microprocessors (digital signal processors, DSPs), or one or more field programmable gate arrays (FPGAs), and the like. For example, when one of the above modules is implemented in the form of a processing element scheduling program code, the processing element may be a general purpose processor, such as a CPU or other processor that can invoke the program code. Further, the modules may be integrated together and implemented in the form of a system-on-a-chip (SOC).

In the embodiments provided in the present disclosure, it should be understood that the devices and methods disclosed may be implemented in other ways. For example, the above-described embodiments of the device are merely schematic, e.g., the division of the described units is merely a logical functional division, and the described units may be divided in other ways when actually implemented, e.g., a plurality of units or components may be combined or may be integrated into another system, or some features may be ignored or not implemented. At another point, the coupling or direct coupling or communication connection between each other shown or discussed may be an indirect coupling or communication connection through some interfaces, devices or units, which may be electrical, mechanical or other forms.

The units illustrated as separated components may or may not be physically separated, and components shown as units may or may not be physical units, i.e., they may be located in a place or may also be distributed over a plurality of network units. A part of or all of these units may be selected to achieve the purpose of the solution of the embodiments according to actual needs.

Furthermore, the functional units in the embodiments of the present disclosure may be integrated in a processing unit, or each unit may be physically present separately; or two or more units may be integrated in a unit. The above integrated units may be realized either in the form of hardware or in the form of hardware plus software functional units.

The above-described integrated unit realized in the form of a software functional unit may be stored in a computer-readable storage medium. The above-described software functional unit stored in a storage medium includes one or more instructions to cause a computer device (which may be a personal computer, a server, or a network device, etc.) or a processor to perform a part of the steps of the method described in the embodiments of the present disclosure.

The above are only specific embodiments of the present disclosure, but the scope of protection of the present disclosure is not limited thereto, and any person skilled in the art can easily think of variations or substitutions within the scope of the technology disclosed in the present disclosure, all of which should be covered by the scope of protection of the present disclosure. Therefore, the scope of protection of the present disclosure shall be subject to the scope of protection of the claims.

1. A movement control method, comprising:
displaying a joystick domain through a first control region of a graphical user interface, wherein the graphical user interface is provided through a terminal device, the graphical user interface comprises the first control region and a second control region, wherein the second control region is located at a periphery of the first control region;
controlling, in response to a first slide operation acting in the first control region, an operation point of the joystick domain to move along with movement of a first touch control point of the first slide operation on the graphical user interface;
in response to a second slide operation acting in the second control region, controlling, based on a position change of a second touch control point of the second slide operation in the second control region, the operation point of the joystick domain to move in the first control region; and
generating a movement control vector based on a relative position between the joystick domain and the operation point, and performing movement control based on the movement control vector.

2. The method according to claim 1, wherein the first control region comprises a first sub-region and a second sub-region, and the second sub-region is located at a periphery of the first sub-region; and wherein displaying the joystick domain through the first control region comprises:
in response to a first touch control operation acting in the first sub-region of the first control region, determining a first touch control position of the first touch control operation as a center of the joystick domain, and displaying the joystick domain; or
in response to a second touch control operation acting in the second sub-region of the first control region, determining the center of the joystick domain based on a second touch control position of the second touch control operation and a center of the first sub-region, and displaying the joystick domain.

3. The method according to claim 2, wherein a radius of a base plate of the joystick domain is a preset value; and wherein determining the center of the joystick domain based on the second touch control position of the second touch control operation and the center of the first sub-region and displaying the joystick domain comprises:
determining a connection line based on the second touch control position of the second touch control operation and the center of the first sub-region; and
generating in the first control region, based on the connection line, the joystick domain with a radius of the preset value, wherein the center of the joystick domain is located on the connection line, a circle corresponding to the operation point of the joystick domain is inscribed with the base plate, and the operation point is located at the second touch control position of the second touch control operation.

4. The method according to claim 2, wherein controlling, in response to the first slide operation acting in the first control region, the operation point of the joystick domain to move along with the movement of the first touch control point of the first slide operation on the graphical user interface comprises:
in response to the first slide operation acting in the first control region, when the first touch control point of the first slide operation is located within the joystick domain, controlling a base plate of the joystick domain to remain stationary, and controlling the operation point of the joystick domain to move along with the movement of the first touch control point of the first slide operation; and
in response to the first touch control point of the first slide operation being located in an area within the first control region other than the joystick domain, controlling the base plate and the operation point of the joystick domain to move along with the movement of the first touch control point of the first slide operation.

5. The method according to claim 1, wherein controlling, based on the position change of the second touch control point of the second slide operation in the second control region, the operation point of the joystick domain to move in the first control region comprises:
displaying in the first control region, based on a starting point of the second slide operation in the second control region, a base plate of the joystick domain in a fixed manner;
determining a connection line between the second touch control point of the second slide operation and a center of the joystick domain, and determining an intersection point between the connection line and an edge of the joystick domain as a position where the operation point of the joystick domain is inscribed with the base plate of the joystick domain; and
controlling, based on the position change of the second touch control point of the second slide operation in the second control region, the operation point of the joystick domain to maintain inscribed with the base plate and move on the base plate of the joystick domain.

6. The method according to claim 5, comprising:
controlling, in response to a third slide operation sliding from the second control region to the first control region, the joystick domain to translate from a current position towards a direction of a current movement control vector until the joystick domain is inscribed with the first control region, wherein the operation point of the joystick domain is displayed at a touch control position of the third slide operation in the first control region.

7. The method according to claim 1, wherein in response to the second slide operation acting in the second control region, controlling, based on the position change of the second touch control point of the second slide operation in the second control region, the operation point of the joystick domain to move in the first control region comprises:
in response to the second slide operation acting in the second control region, determining a connection line based on the second touch control point of the second slide operation and a center of the first control region, and determining an intersection point between the connection line and an edge of the first control region as a point where the operation point and a base plate of the joystick domain are inscribed with the first control region; and
based on the position change of the second touch control point of the second slide operation in the second control region, controlling the operation point and the base plate of the joystick domain to move in the first control region while maintaining inscribed with the first control region.

8. The method according to claim 7, wherein an angle at which the base plate moves in the first control region, and an angle at which the operation point moves in the first control region are the same as an angle at which the second touch control point of the second slide operation moves in the second control region.

9. (canceled)

10. A non-transitory computer-readable storage medium, storing a computer program, wherein the computer program, when executed by a processor, causes the processor to perform a movement control method, and the method comprises:
displaying a joystick domain through a first control region of a graphical user interface, wherein the graphical user interface is provided through a terminal device, and the graphical user interface comprises the first control region and a second control region, wherein the second control region is located at a periphery of the first control region;
controlling, in response to a first slide operation acting in the first control region, an operation point of the joystick domain to move along with movement of a first touch control point of the first slide operation on the graphical user interface;
in response to a second slide operation acting in the second control region, controlling, based on a position change of a second touch control point of the second slide operation in the second control region, the operation point of the joystick domain to move in the first control region; and
generating a movement control vector based on a relative position between the joystick domain and the operation point, and performing movement control based on the movement control vector.

11. An electronic device, comprising:
a processor; and
a memory, configured to store an executable instruction of the processor; wherein
the processor, through executing the executable instruction, is configured to perform:
displaying a joystick domain through a first control region of a graphical user interface, wherein the graphical user interface is provided through a terminal device, and the graphical user interface comprises the first control region and a second control region, wherein the second control region is located at a periphery of the first control region;
controlling, in response to a first slide operation acting in the first control region, an operation point of the joystick domain to move along with movement of a first touch control point of the first slide operation on the graphical user interface;
in response to a second slide operation acting in the second control region, controlling, based on a position change of a second touch control point of the second slide operation in the second control region, the operation point of the joystick domain to move in the first control region; and
generating a movement control vector based on a relative position between the joystick domain and the operation point, and performing movement control based on the movement control vector.

12. The method according to claim 1, further comprising:
determining a touch control position of the first slide operation by monitoring a slide event and a point contacting event, or
determining the touch control position of the first slide operation by monitoring a screen pressure change.

13. The electronic device according to claim 11, wherein the first control region comprises a first sub-region and a second sub-region, the second sub-region is located at a periphery of the first sub-region, and the processor is specifically configured to perform:
in response to a first touch control operation acting in the first sub-region of the first control region, determining a first touch control position of the first touch control operation as a center of the joystick domain, and displaying the joystick domain; or
in response to a second touch control operation acting in the second sub-region of the first control region, determining the center of the joystick domain based on a second touch control position of the second touch control operation and a center of the first sub-region, and displaying the joystick domain.

14. The electronic device according to claim 13, wherein a radius of a base plate of the joystick domain is a preset value, and the processor is specifically configured to perform:
determining a connection line based on the second touch control position of the second touch control operation and the center of the first sub-region; and
generating in the first control region, based on the connection line, the joystick domain with a radius of the preset value, wherein the center of the joystick domain is located on the connection line, a circle corresponding to the operation point of the joystick domain is inscribed with the base plate, and the operation point is located at the second touch control position of the second touch control operation.

15. The electronic device according to claim 13, wherein the processor is specifically configured to perform:
in response to the first slide operation acting in the first control region, when the first touch control point of the first slide operation is located within the joystick domain, controlling a base plate of the joystick domain to remain stationary, and controlling the operation point of the joystick domain to move along with the movement of the first touch control point of the first slide operation; and
in response to the first touch control point of the first slide operation being located in an area within the first control region other than the joystick domain, controlling the base plate and the operation point of the joystick domain to move along with the movement of the first touch control point of the first slide operation.

16. The electronic device according to claim 11, wherein the processor is specifically configured to perform:
displaying in the first control region, based on a starting point of the second slide operation in the second control region, a base plate of the joystick domain in a fixed manner;
determining a connection line between the second touch control point of the second slide operation and a center of the joystick domain, and determining an intersection point between the connection line and an edge of the joystick domain as a position where the operation point of the joystick domain is inscribed with the base plate of the joystick domain; and
controlling, based on the position change of the second touch control point of the second slide operation in the second control region, the operation point of the joystick domain to maintain inscribed with the base plate and move on the base plate of the joystick domain.

17. The electronic device according to claim 16, wherein the processor is further configured to perform:
controlling, in response to a third slide operation sliding from the second control region to the first control region, the joystick domain to translate from a current position towards a direction of a current movement control vector until the joystick domain is inscribed with the first control region, wherein the operation point of the joystick domain is displayed at a touch control position of the third slide operation in the first control region.

18. The electronic device according to claim 11, wherein the processor is specifically configured to perform:
in response to the second slide operation acting in the second control region, determining a connection line based on the second touch control point of the second slide operation and a center of the first control region, and determining an intersection point between the connection line and an edge of the first control region as a point where the operation point and a base plate of the joystick domain are inscribed with the first control region; and
based on the position change of the second touch control point of the second slide operation in the second control region, controlling the operation point and the base plate of the joystick domain to move in the first control region while maintaining inscribed with the first control region.

19. The electronic device according to claim 18, wherein an angle at which the base plate moves in the first control region, and an angle at which the operation point moves in the first control region are the same as an angle at which the second touch control point of the second slide operation moves in the second control region.

20. The electronic device according to claim 11, wherein the processor is further configured to perform:
determining a touch control position of the first slide operation by monitoring a slide event and a point contacting event; or
determining the touch control position of the first slide operation by monitoring a screen pressure change.

21. The non-transitory computer-readable storage medium according to claim 10, wherein the first control region comprises a first sub-region and a second sub-region, and the second sub-region is located at a periphery of the first sub-region; and wherein displaying the joystick domain through the first control region comprises:
in response to a first touch control operation acting in the first sub-region of the first control region, determining a first touch control position of the first touch control operation as a center of the joystick domain, and displaying the joystick domain; or
in response to a second touch control operation acting in the second sub-region of the first control region, determining the center of the joystick domain based on a second touch control position of the second touch control operation and a center of the first sub-region, and displaying the joystick domain.
